(19) United States
(12) Patent Application Publication
(10) Pub. No.: US 2005/0193342 A1
(43) Pub. Date: Sep. 1, 2005

(54) Simultaneous wireless broadcasting of video and graphical content

(76) Inventors: Yueting Yen, Fremont, CA (US); Jianpeng Dong, Santa Clara, CA (US); Miin Yang Chen, Palo Alto, CA (US); Thomas Lo, Cupertino, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/051,890

(22) Filed: Feb. 4, 2005

Related U.S. Application Data
(60) Provisional application No. 60/542,247, filed on Feb. 4, 2004.

(51) Int. Cl. G06F 17/00

(52) U.S. Cl. 715/716; 348/14.02

(57) ABSTRACT

Apparati, methods, and computer-readable media for simultaneously broadcasting video content (26-29) and graphical content (40) over a wireless network. An apparatus embodiment of the present invention comprises at least one central computer (1) adapted to process video content (26-29) and graphical content (40); a plurality of presentation modules (2) communicatively coupled to the central computer (1) via a wireless network; and associated with the central computer (1), means (53, 60) for simultaneously broadcasting to the presentation modules (2) the video content (26-29) and the graphical content (40).

### RELATED APPLICATION

This patent application is related to, and claims priority benefit under 35 U.S.C. §119(e) to, U.S. provisional patent application 60/542,247, entitled “Robust System for Wireless Projection of Computer Display and Rendering of Motion Video Contents,” filed Feb. 4, 2004, which provisional patent application is hereby incorporated by reference in its entirety into the present utility patent application.

### TECHNICAL FIELD

This invention pertains to the field of broadcasting video and graphical content over wireless networks.

### BACKGROUND ART

When giving audio-visual presentations to groups of people, it is often convenient for the presenter to have stored the presentation on his or her computer in digital form. The content for the presentation may be in the form of continuously moving images, i.e., video; and/or graphical content, i.e., still images from a word processor, spreadsheet, or slide show presentation program. It would be convenient for this content to be conveyed to displays associated with computers operated by people in the audience. It would be convenient for the content to be conveyed to the audience by wireless means to avoid the clutter associated with wires and cables. It would be useful for the video and graphical content to be conveyed simultaneously, and for the system to have the capability to convey video content that is imbedded within a program, such as a slide show presentation program. Finally, it would be useful to have the capability to have more than one presenter able to convey video and graphical information to the same audience.

The above goals are all satisfied by the invention described herein.

### DISCLOSURE OF INVENTION

Apparati, methods, and computer-readable media for simultaneously broadcasting video content (26-29) and graphical content (40) over a wireless network. An apparatus embodiment of the present invention comprises at least one central computer (1) adapted to process video content (26-29) and graphical content (40); a plurality of presentation modules (2) communicatively coupled to the central computer (1) via a wireless network; and associated with the central computer (1), means (53, 60) for simultaneously broadcasting to the presentation modules (2) the video content (26-29) and the graphical content (40).

### BRIEF DESCRIPTION OF THE DRAWINGS

These and other more detailed and specific objects and features of the present invention are more fully disclosed in the following specification, reference being had to the accompanying drawings, in which:

FIG. 1 is a block diagram illustrating the overall architecture of the present invention;

FIG. 2 is a block diagram illustrating modules associated with a central computer 1 of the present invention; and

FIG. 3 is a block diagram illustrating modules associated with a presentation module 2 of the present invention.

### DETAILED DESCRIPTION OF THE PREFERRED EMBODIMENT

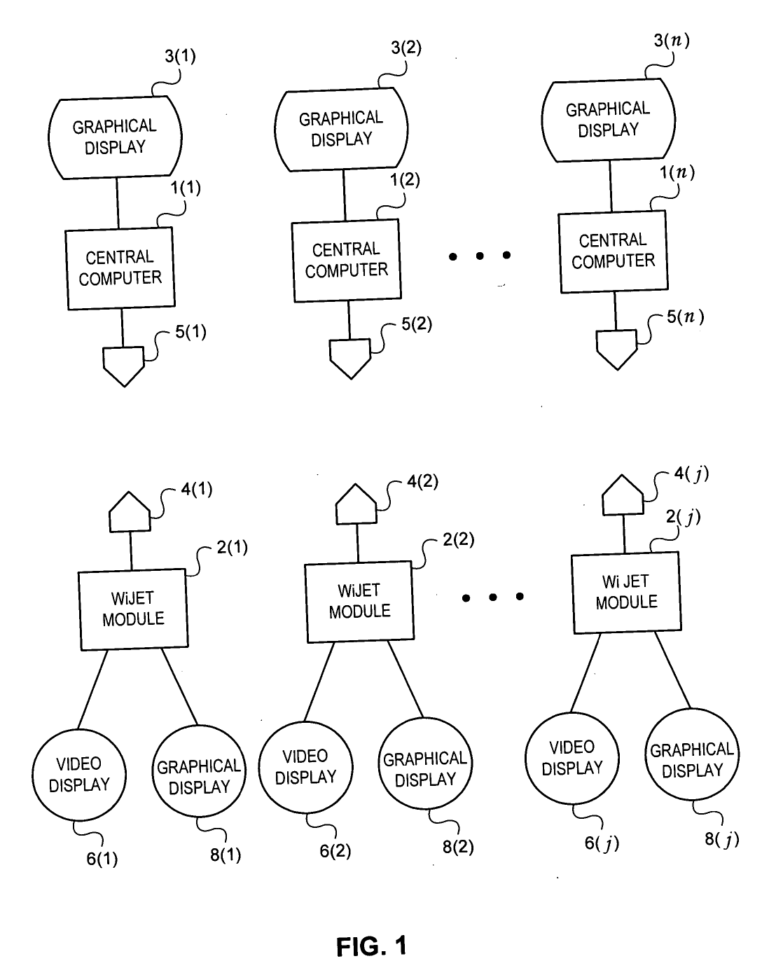

FIG. 1 illustrates the overall architecture of the present invention. At least one central computer 1 is communicatively coupled to a plurality of presentation modules 2 over a wireless network. Only one such central computer 1 is coupled to the modules 2 at any given time. In the Figures, a presentation module 2 is referred to as a WiJET module, for “Wireless proJEcTion”. The wireless signals are sent from the central computer 1 to the plurality of WiJET modules 2 using an antenna 5 associated with each central computer 1 and an antenna 4 associated with each WiJET module 2. Each central computer 1 typically has associated therewith a graphical display 3, so that the user of computer 1 can get a visual indication of graphical content 40 stored in computer 1 and executing thereon. Such graphical content 40 may be associated with a word processing program, a spreadsheet, a slide show presentation program, or some other application program.

Each WiJET module 2 typically has associated therewith a video display 6 and a graphical display 8. Each graphical display 8 will display whatever is displayed on the graphical display 3 associated with the central computer 1 to which the corresponding WiJET module 2 is communicatively coupled.

Each video display 6 associated with a WiJET module 2 will display video content 26-29 that is broadcast from the central computer 1 to the WiJET module 2. It is not necessary for central computer 1 to itself have a video display for simultaneously displaying the same video content 26-29, but in some embodiments there is a video display 25 associated with one or more of central computers 1.

An example of a suitable graphical display 8 is a VGA (Video Graphics Adapter) display. Video display 6 can be a projector or a television monitor. In some embodiments of the present invention, the video content 26-29 and the graphical content 40 are both rendered by a WiJET module 2 on a single high definition display, such as a high definition television monitor or an SXGA display.

In some embodiments of the present invention, there is more than one central computer 1. In these embodiments, there is some means, such as a software switch within each central computer 1, for switching off the connectivity between that central computer 1 and the plurality of WiJET modules 2, in order to give another central computer 1 the chance to communicate with said plurality of WiJET modules 2. As stated previously, a given WiJET module 2 can be connected to only a single central computer 1 at any given time. These embodiments are useful when more than one presenter wishes to give a presentation to the same audience. The first presenter, controlling computer 1(1), broadcasts his or her presentation to a large number of audience members, each having his or her own WiJET module 2, and then when the first presenter is done with his or her presentation, said first presenter yields the floor to the second presenter.

It will be appreciated from the above-described architecture that there is a great deal of freedom in the location of the presenters and the audience members. The audience members may be all in a single room, or in adjacent rooms within a building owned by an enterprise. Similarly, the presenters may be all in the same room, and, if so, at various different locations within the room. Alternatively, the presenters may be in different rooms. Thus, the present invention offers great flexibility and ease of use in seamlessly transitioning from one presenter to another.

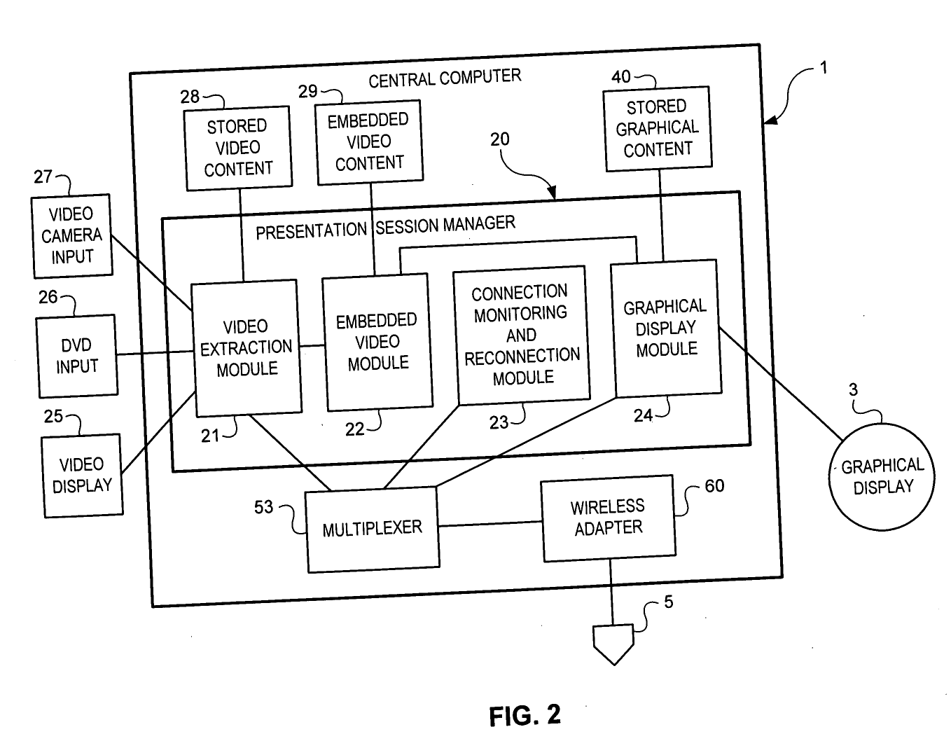

FIG. 2 illustrates modules associated with a central computer 1. As stated previously, each central computer 1 usually has associated therewith a graphical display 3, and may have associated therewith a video display 25. It is assumed that there is some graphical content 40 stored within computer 1, as well as some video content 26-29 associated with computer 1. The video content may be a real-time DVD input 26, a real-time video camera input 27, stored video content 28, and/or video content 29 that is embedded within an application program such as Microsoft PowerPoint or some other slide show presentation program.

Many of the inventive aspects associated with computer 1 are contained within Presentation Session Manager (PSM) 20. Modules 21-24 contained within PSM 20 are normally implemented in software, but can be implemented in any combination of software, firmware and/or hardware. When implemented in software, these modules 21-24 can be embodied on a computer-readable medium or a plurality of computer-readable media, such as one or more hard disks, floppy disks, CDs, DVDs, etc. The digital data streams processed by PSM 20 are multiplexed using multiplexer 53 and sent to wireless adapter 60 for modulation onto an RF carrier and subsequent radiation via antenna 5. Wireless adapter 60 may follow any suitable wireless protocol, such as IEEE 802.11(b) or 802.11(g), commonly known as WiFi.

One of the modules within PSM 20 is video extraction module 21, which takes as inputs the video content from DVD input 26, video camera input 27, and/or stored video content 28, and processes this content for subsequent transmission, as will be more fully described below. Optionally, module 21 renders this video content and displays it on video display 25.

Graphical display module 24 processes graphical content 40, displays it on graphical display. 3, and sends it through wireless adapter 60 over the wireless network, as will be more fully described below.

Embedded video module 22 detects instances of embedded video 29 embedded within application programs. Module 22 separates the embedded video 29 from the application program, sending the video 29 to video extraction module 21 for further processing and the application program itself to graphical display module 24 for further processing. Embedded video module 22, in an unique aspect of the present invention, is able to find this embedded video 29 by looking for video objects embedded in user files stored within computer 1. As used herein, “object” is defined as that term is ordinarily used in the field of object oriented programming.

Finally, connection monitoring and reconnection module 23 monitors which WiJET modules 22 the central computer 1 is connected to at any given time, and reestablishes connections that are broken.

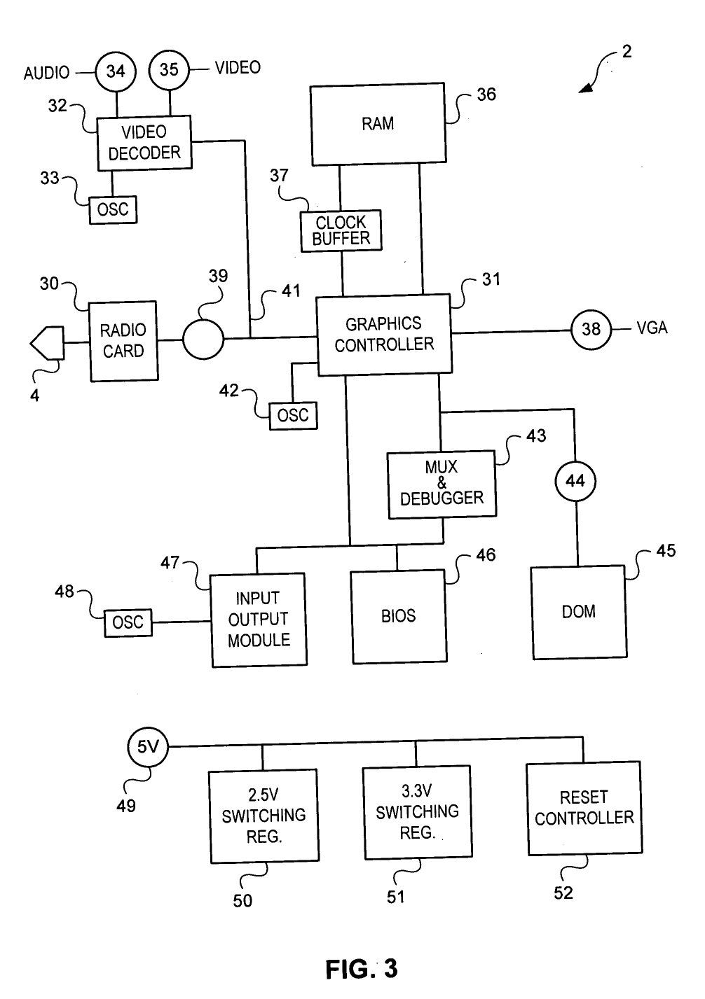

FIG. 3 illustrates apparatus contained within a WiJET module 2. It will be appreciated that the modules illustrated in FIG. 3 are associated with one embodiment only, and many other configurations are possible within the metes and bounds of the present invention. Radio card 30 is coupled to antenna 4 and is operable with the same wireless protocol used by wireless adapter 60. The SSID (Service Set IDentifier) of the WiJET module 2 is stored within said radio card 30. In the case where the wireless protocol is an 802.11 WiFi protocol, a 33 MHz signal is output from radio card 30 and passes through PCI (Peripheral Component Interconnect) connector 39, where it travels on PCI bus 41 to two important components of WiJET module 2: video decoder 32 and graphics controller 31. In the illustrated embodiment, video decoder 32 is an MPEG 2 decoder, such as an EM8475, having its own CPU that is clocked by a 27 MHz oscillator 33. The outputs of video decoder 32 are an audio output appearing on audio connector 34 and a video output appearing on video connector 35, which may be an S-video connector that can accommodate S-video, component, and composite video signals. Video display 6 is coupled to connections 34 and 35.

In the illustrated embodiment, graphics controller 31 is a combined CPU and 133 MHz VGA controller clocked by a 14 MHz crystal oscillator 42. Graphics controller 31 outputs a 48 KHz signal to VGA connector 38 for purposes of feeding the signal to graphical display 8. Graphics controller 31 is communicatively coupled via a 100 MHz connection to RAM 26, such as 64 MB of SDRAM, which stores software and is driven by clock buffer 37 over another 100 MHz connection.

Graphics controller 31 is also coupled to a proprietary multiplexer and debugging chip 43 containing debugging logic. Graphics controller 31 is further coupled, via IDE connector 44, to DOM 45, e.g. 32 MB of random access flash memory containing firmware. DOM 45 is unpluggable and executes out of RAM 36. Graphics controller 31 is also coupled to BIOS 46, which may be on flash memory, which boots up WiJET module 2, and at boot-up time checks DOM 45 to verify that it is a legitimate DOM. In one embodiment, the verification process is as follows. Each DOM 45 contains a unique vendor serial number provided by the vendor at the time of manufacture. This vendor serial number cannot be written over. The system integrator (manufacturer of WiJET module 2) provides a unique system integrator serial number that will be associated with that DOM 45. A cryptographic or error checking algorithm, such as the CRC (Cyclic Redundancy Check)-16 algorithm, then uses the vendor serial number and the system integrator serial number to generate an electronic signature. The system integrator serial number and the electronic signature is then written onto DOM 45. At the time of booting up WiJET module 2, BIOS 46 reads the vendor serial number and the system integrator serial number from DOM 45 and calculates the electronic signature using the same algorithm that was used to create the electronic signature initially. If the electronic signature newly calculated by BIOS 46 matches the electronic signature stored in DOM 45, BIOS 46 allows the boot-up of WiJET module 2 to continue. Otherwise, the boot-up is halted.

Finally, graphics controller 31 is also coupled to input/output module 47, which is clocked by a 31 KHz crystal oscillator 48, enabling the user to input certain interesting parameters into WiJET module 2. Examples of such parameters include:
whether the video signals follow the American NTSC standard or the European PAL standard;
whether the video output 35 is S-video, composite video, or component video;
the desired durations for slide shows over VGA connector 38; and
security parameters, in embodiments where an encryption scheme, such as WEP (Wired Equivalent Privacy) is used in the wireless networking.

The components within WiJET module 2 are powered by a power supply, which, in the illustrated embodiment, has three power levels: 5 volts, provided by power jack 49; 2.5 volts, provided by 250 KHz switching regulator 50; and 3.3 volts, provided by 250 KHz switching regulator 51. The power supply also comprises a reset controller 52, a button which, when pushed by the user, resets all the parameters back to the default parameters, i.e., those provided at the time of manufacture of module 2.

The software modules contained within WiJET module 2 can be embodied on a computer-readable medium or a plurality of computer-readable media, such as one or more hard disks, floppy disks, CDs, DVDs, etc.

In a method embodiment of the present invention, a central computer 1 and a plurality of WiJET modules 2 are configured into a wireless network. Normally, each WiJET module 2 should be in a ready state before a PSM 20 attempts to connect with said module 2.

In a typical wireless network, there is one “access point” and a plurality of “stations”. The present invention offers great flexibility in that any one of the central computer 1 and the plurality of WiJET modules 2 can be declared to be this access point. The designated access point then selects a channel on which the subsequent wireless communications will take place from among a plurality of possible channels that are associated with the particular wireless network. For example, in the United States, 11 channels are available in a 802.11(g) or (b) network.

The access point searches the wireless RF space, identifies currently busy channels, and identifies the SSIDs in use by the central computer 1 and the WiJET modules 2. The access point selects the clearest channel by using a proprietary algorithm in which the access point measures the amount of energy in each of the possible channels, and selects that channel having the least amount of energy as the channel for the subsequent wireless communications. From the SSID information, each WiJET module 2 and PSM 20 chooses a name for itself from a pre-established list of possible names. For example, a chosen name might be WiJET0002. Then, in one embodiment, each WiJET module 2 displays a “banner” on graphical display 8 giving the name and channel information for that module 2. This allows the human user of that module 2 to instruct PSM 20 to use the same name for connection and operation. This provides visual feedback to the human user of PSM 20, enabling said user to select which of the WiJET modules 2 he or she wishes to communicate with. Once a WiJET module 2 is in the ready state, module 2 starts a daemon (software program) that listens for an initial connection request from a PSM 20.

For initializing PSM 20, the human user is asked to identify which WiJET modules 2 he or she wishes to be connected with. PSM 20 then initiates a method to automatically configure the associated wireless adapter 60 to match the user's WiJET module 2 by SSID. If wireless adapter 60 is not compatible with this method, the user is asked to configure wireless adapter 60 manually. Thus, the SSID of wireless adapter 60 is set either automatically or manually. Now that the wireless link has been established by virtue of central computer 1 and all of the WiJET modules 2 having an SSID, PSM 20 initiates the following initial connection protocol.

PSM 20 broadcasts an “are you there” message for each selected WiJET module 2 by name, and waits for a reply. The selected WiJET module 2 then replies with its own IP (Internet Protocol) identification and MAC (Media Access Control) address, thus telling PSM 20 that module 2 is there. PSM 20 then determines IP connectability, which is governed by whether PSM 20 and WiJET module 2 are in the same IP subnetwork. If not, PSM 20 assigns a connectable IP address to WiJET module 2. WiJET module 2 then retains or accepts its connectable IP address, and an initial exchange is initiated between PSM 20 and WiJET module 2. Information in the initial exchange from PSM 20 typically includes the resolution of graphical display 3, e.g., the VGA resolution. This allows WiJET module 2 to automatically synchronize the VGA resolution of its graphical display 8 with the resolution of graphical display 3 of central computer 1, i.e., WiJET module 2 uses the same resolution as computer 1. If WiJET module 2 does not have the resolution called for, module 2 sends back an error message to PSM saying that it cannot connect.

PSM 20 then starts up its connection monitoring and reconnection module (daemon) 23, and WiJET module 2 starts a similar daemon contained within WiJET module 2. This software runs in the background and has different flavors for PSM 20 and for WiJET module 2. This software is used to automatically restore temporarily broken connections in real time.

The system then enters the computer display replication operation for graphical display 8. This operation is based on the remote frame buffer (RFB) protocol, with the following modifications.

When WiJET module 2 is connected to PSM 20, WiJET module 2 monitors for any Initial Connection requests from another PSM 20. If one arrives, WiJET module 2 replies with a rejection message. This function is performed by software within DOM 45. Note that a PSM 20 may voluntarily withdraw from connection to a WiJET module 2. This allows another PSM 20 to instantly utilize the given WiJET module 2. This voluntary withdrawal can be accomplished by the human user of PSM 20 pressing a button on computer 1 telling PSM 20 to disconnect. PSM 20 accepts and retains all the connections with all of the WiJET modules 2 in the wireless network. When there are multiple WiJET modules 2, PSM 20 multicasts display updates periodically so that all of the connected WiJET modules 2 obtain and display the same images. Protocol control messages sent from central computer 1 to the WiJET modules 2 during computer display replication remain in unicast rather than in multicast. This is because unicast is more reliable since it has retransmission built in.

For video rendering, the present invention offers a proprietary Motion Video Streaming protocol that allows PSM 20 to deliver video content 26-29 to a plurality of WiJET modules 2 to be rendered. The same video content 26-29 could also be rendered locally by computer 1, but it does not have to be so rendered, as previously stated. Video decoder 32 within WiJET module 2 renders the video. This video may be coded using any available digital standard, such as MPEG or WMV. As stated previously, one of the important features of the present invention is that it allows for simultaneous graphical content 40 rendering and video content 26-29 rendering.

The video content 26-29 may be rendered to either or both of video display 6 or graphical display 8. When the video content 26-29 is rendered to graphical display 8, the protocol allows the presenter to specify the location and size of the video playing area. In effect, the video overrides and becomes embedded in the overall image from the graphical replication. This embedding is done by software within PSM 20. The Motion Video Streaming protocol also supports many video playing options, including pause, advance, and rewind. These options are controlled by software within PSM 20.

An important feature of the present invention is connection monitoring and reconnecting. PSM 20 and WiJET module 2 constantly monitor their connectivity. This is based upon a “heartbeat” scheme in which a clock controls a small packet (heartbeat) to see if PSM 20 and WiJET module 2 are still connected. Whenever an expected heartbeat has not arrived in time, WiJET module 2 performs operations that return it to a freshly rebooted state. WiJET module 2 then does another clear channel search. This assures that if, for example, the break in the connectivity was caused by newly introduced RF interference, the system will have avoided the noisy RF channel. WiJET module 2 is now ready to receive initial connection requests.

PSM 20 maintains the context and state of the broken connection. This information is tracked by connection monitoring and reconnection module 23. PSM 20 initiates a request for initial connection with any WiJET module 2 with which it has lost connectivity. Several repeats are attempted, since the breakage and corresponding WiJET 2 action may take a few seconds to a few minutes (e.g., in the case where the break of connectivity was caused by the accidental unplugging of a power cord connecting commercial power mains to the power supply of WiJET module 2).

In broadcasting video 29 that is embedded within application programs, the present invention employs special techniques, because if PSM 20 simply sent the overall application program using computer display module 24, the data rate of the embedded video 29 would inevitability exceed that of the wireless channel (which is typically between 10 Mbps and 100 Mbps). Additionally, a big load would be placed on the CPU of computer 1. The special technique employed by the present invention is to recognize the embedded video 29 at its source. This is done by embedded video module 22, which constantly looks for embedded video 29 running on computer 1 by means of looking for video objects within user files. As used herein, “object” is defined as that term is used in the field of object oriented programming. For example, if the application program is Microsoft's PowerPoint, each slide having a video clip has a link to a MPEG or other video file in the computer 1. Embedded video module 22 clicks on the link and queries the PowerPoint software to obtain the file path to the MPEG file. Embedded video module 22 extracts this embedded video content 29 and sends it to video extraction module 21 to deliver the embedded video content 29 to WiJET module 2 for rendering. This insures good quality of the motion video as it plays within the effective data rate provided by state-of-the-art wireless devices. Embedded video module 22 additionally sends the application program envelope to graphical display module 24 for broadcast to the WiJET modules 2. In one embodiment, each WiJET module 2 renders the embedded video content 29 and the application program envelope on the same display, whether it be graphical display 8 or video display 6. In this embodiment, embedded video module 22 informs each WiJET module 2 of the location and area on the display 8, 6 where the embedded video content 29 should be rendered. This allows WiJET module 2 to replicate the contents of whatever is being displayed on graphical display 3 within the constraint of the useable connection bandwidth.

The invention allows for preloading a set of images to be subsequently displayed by a WiJET module 2 in a repeated manner. The set of images are stored in DOM 45. This allows a user of a WiJET module 2 to deploy the WiJET module 2 without a connected PSM 20. Several playing options are available in this embodiment. One option is that the WiJET module 2 can play each image for a specified user duration. Another option is that a given set of images can be displayed either sequentially or randomly. These options can be set by the human user providing inputs to input/output module 47. In this embodiment, PSM 20 can be used to assist the user in uploading and managing the preloaded images, which can then be sent over the wireless connection to the WiJET module 2.

The above description is included to illustrate the operation of the preferred embodiments and is not meant to limit the scope of the invention. The scope of the invention is to be limited only by the following claims. From the above discussion, many variations will be apparent to one skilled in the art that would yet be encompassed by the spirit and scope of the present invention. For example, many features of the present invention can be employed when the connection between central computer 1 and WiJET modules 2 is a wired connection rather than a wireless connection.

1. Apparatus for simultaneously broadcasting video content and graphical content over a wireless network, said apparatus comprising:
at least one central computer adapted to process video content and graphical content;
a plurality of presentation modules communicatively coupled to the central computer via a wireless network; and
associated with the central computer, means for simultaneously broadcasting to the presentation modules the video content and the graphical content.

2. The apparatus of claim 1 wherein at least one presentation module has associated therewith a video display and a graphical display.

3. The apparatus of claim 2 wherein the video display is a display from the group of displays consisting of a projector and a television monitor.

4. The apparatus of claim 2 wherein the graphical display is a VGA display.

5. The apparatus of claim 1 wherein at least one presentation module has associated therewith a single display capable of rendering both the video content and the graphical content.

6. The apparatus of claim 1 comprising a plurality of central computers, said apparatus further comprising means for preventing a presentation module from being communicatively coupled to more than one central computer at any one time.

7. Apparatus for simultaneous broadcasting video and graphical content over a wireless network, said apparatus comprising:
a content gathering module running on a digital computer, said content gathering module comprising:
a video extraction module coupled to at least one source of video content;
a graphical display module coupled to at least one source of graphical content;
coupled to the video extraction module and to the graphical display module, a multiplexer having an output consisting of a combined video and graphical signal; and
coupled to the multiplexer, a wireless adapter for modulating the combined video and graphical signal onto a wireless carrier for broadcast.

8. The apparatus of claim 7 wherein the video content comprises at least one type of content from the group of content types consisting of:
stored video content;
real-time video camera input;
real-time DVD input; and
embedded video content.

9. The apparatus of claim 7 wherein at least one source of video content consists of video content embedded within an application program, and said apparatus further comprises:
coupled to the embedded video content, to the video extraction module, and to the graphical display module, an embedded video module for detecting the presence of embedded video content within the computer; wherein:
the embedded video module sends the embedded video content to the video extraction module, and sends the application program to the graphical display module.

10. The apparatus of claim 9 wherein the embedded video module detects embedded video content within the computer by looking for video objects within user files.

11. Apparatus for simultaneously rendering digital video content and digital graphical content, said apparatus comprising:
a radio card for receiving the video content and the graphical content over a wireless link;
coupled to the radio card, a video decoder for rendering the video content; and
coupled to the radio card, a graphics controller for rendering the graphical content.

12. The apparatus of claim 11 further comprising, coupled to the video decoder and to the graphics controller, an input/output module for permitting user modification of operating parameters.

13. The apparatus of claim 12 wherein said operating parameters comprise at least one parameter from the group of parameters consisting of:
whether the NTSC or PAL video standard is employed;
whether the video content is rendered in S-video, composite video, or component video;
user-selected durations for slide shows rendered by the graphics controller; and
configuration of encryption parameters.

14. A method for initializing simultaneous broadcasting of video content and graphical content over a wireless network, said method comprising the steps of:
configuring a plurality of presentation modules and a central computer into a wireless network;
designating one of the presentation modules and the central computer as an access point; and
having the access point select a channel for wireless communications from among a plurality of possible channels.

15. The method of claim 14 wherein the access point selects the channel for wireless communications by performing the following steps:
measuring an amount of energy in each of the possible channels; and
selecting a channel having the least amount of energy as the channel for wireless communications.

16. The method of claim 14 wherein, following the step of having the access point select a channel, each presentation module and the central computer chooses a name for itself from a pre-established list of possible names.

17. A method for setting up IP (Internet Protocol) connectability between a central computer and a video and graphical presentation module communicatively coupled to the central computer in a wireless network, said method comprising the steps of:
the central computer calling for the presentation module by name;
the presentation module replying with IP identification information and a MAC address;
the central computer determining whether the central computer and the presentation module are in the same IP subnetwork; and
when the central computer determines that the central computer and the presentation module are not in the same IP subnetwork, assigning a connectable IP address to the presentation module.

18. The method of claim 17 further comprising the step of the central computer conveying to the presentation module a resolution of a display device associated with the central computer.

19. A method for replicating computer display content from a central computer to a plurality of presentation modules, said method comprising the steps of:
a computer display module that operates in the central computer in multicast mode sending the computer display content to the plurality of presentation modules;
allowing the central computer to voluntarily withdraw from connections to presentation modules to allow another computer to connect to the presentation modules; and
sending protocol control messages from the central computer to the presentation modules in unicast mode.

20. A method for remotely rendering motion video content on a plurality of presentation modules, said method comprising the steps of:
equipping each presentation module with a graphical display and a video display;
rendering the motion video content to either or both of the graphical display and the video display associated with each presentation module; and
when the motion video content is rendered to a graphical display, allowing a user to specify a location and a size of an area within the graphical display, within which the motion video content is rendered.

21. A method for monitoring and reconnecting wireless connections between a central computer that broadcasts video and graphical information over a wireless network to a plurality of presentation modules, said method comprising the steps of:
sending packets between the central computer and the presentation modules indicative of connectivity between the central computer and the presentation modules;
when a packet does not arrive within a preselected period of time, concluding that a connection between the central computer and a presentation module has been lost; and
when a connection has been lost, rebooting the disconnected presentation module.

22. A method for broadcasting video content embedded within an application program running on a central computer from the central computer to a plurality of presentation modules over a wireless network, said method comprising the steps of:
determining that embedded video is executing on the central computer;
stripping the embedded video from an application program in which it is embedded;
processing the stripped embedded video by a video extraction module for broadcast to the plurality of presentation modules; and
processing the application program by a graphical display module for broadcast to the plurality of presentation modules, wherein maximum data rates handled by said graphical display module are lower than maximum data rates handled by said video extraction module.

23. The method of claim 22 wherein the determining step comprises looking for video objects within user files located on the central computer.

24. A method for displaying in a repeated manner a set of images on a presentation module, said method comprising the steps of:
loading the images into a central computer;
having the central computer send the images to the presentation module over a wireless connection; and
feeding display parameters into the presentation module.

25. At least one computer-readable medium containing computer program instructions for initializing simultaneous broadcasting of video content and graphical content over a wireless network, said computer program instructions performing the steps of:
configuring a plurality of presentation modules and a central computer into a wireless network;
designating one of the presentation modules and the central computer as an access point; and
having the access point select a channel for wireless communications from among a plurality of possible channels.

26. At least one computer-readable medium containing computer program instructions for setting up IP (Internet Protocol) connectability between a central computer and a video and graphical presentation module communicatively coupled to the central computer in a wireless network, said computer program instructions performing the steps of:
the central computer calling for the presentation module by name;
the presentation module replying with IP identification information and a MAC address;
the central computer determining whether the central computer and the presentation module are in the same IP subnetwork; and
when the central computer determines that the central computer and the presentation module are not in the same IP subnetwork, assigning a connectable IP address to the presentation module.

27. At least one computer-readable medium containing computer program instructions for replicating computer display content from a central computer to a plurality of presentation modules, said computer program instructions performing the steps of:
a computer display module that operates in the central computer in multicast mode sending the computer display content, to the plurality of presentation modules;
allowing the central computer to voluntarily withdraw from connections to presentation modules to allow another computer to connect to the presentation modules; and
sending protocol control messages from the central computer to the presentation modules in unicast mode.

28. At least one computer-readable medium containing computer program instructions for remotely rendering motion video content on a plurality of presentation modules, said computer program instructions performing the steps of:
equipping each presentation module with a graphical display and a video display;
rendering the motion video content to either or both of the graphical display and the video display associated with each presentation module; and
when the motion video content is rendered to a graphical display, allowing a user to specify a location and a size of an area within the graphical display, within which the motion video content is rendered.

29. At least one computer-readable medium containing computer program instructions for monitoring and reconnecting wireless connections between a central computer that broadcasts video and graphical information over a wireless network to a plurality of presentation modules, said computer program instructions performing the steps of:
sending packets between the central computer and the presentation modules indicative of connectivity between the central computer and the presentation modules;
when a packet does not arrive within a preselected period of time, concluding that a connection between the central computer and a presentation module has been lost; and
when a connection has been lost, rebooting the disconnected presentation module.

30. At least one computer-readable medium containing computer program instructions for broadcasting video content embedded within an application program running on a central computer from the central computer to a plurality of presentation modules over a wireless network, said computer program instructions performing the steps of:
determining that embedded video is executing on the central computer;
stripping the embedded video from an application program in which it is embedded;
processing the stripped embedded video by a video extraction module for broadcast to the plurality of presentation modules; and
processing the application program by a graphical display module for broadcast to the plurality of presentation modules, wherein maximum data rates handled by said graphical display module are lower than maximum data rates handled by said video extraction module.

31. At least one computer-readable medium containing computer program instructions for displaying in a repeated manner a set of images on a presentation module, said computer program instructions performing the steps of:
loading the images into a central computer;
having the central computer send the images to the presentation module over a wireless connection; and
feeding display parameters into the presentation module.
